(19) United States
(12) Patent Application Publication
(10) Pub. No.: US 2008/0081208 A1
(43) Pub. Date: Apr. 3, 2008

(54) Method and apparatus for improving the distribution of compressive stress

(76) Inventors: Paul S. Prevey, Cincinnati, OH (US); John E. Haas, Hebron, KY (US)

Correspondence Address: Mark F. Smith, 905 Ohio Pike, Cincinnati, OH, 45245, US

(21) Appl. No.: 11/903,623

(22) Filed: Sep. 24, 2007

Related U.S. Application Data
(60) Provisional application No. 60/848,076, filed on Sep. 29, 2006.

(51) Int. Cl. B32B 33/00; C21D 7/04

(52) U.S. Cl. 428/610; 72/379.2; 72/53

(57) ABSTRACT

A surface treatment element having a textured surface with a plurality of deforming features is pressed against the surface of an article to induce deep and shallow layers of compressive residual stress to form a continuous layer of compressive residual stress extending from the surface to a depth beneath the surface. A method whereby a surface treatment apparatus is pressed into the surface of the apparatus to cause Hertzian loading thereby inducing a deep, high magnitude compressive residual stress below the surface. The deforming features of the surface treatment element cause the lateral displacement of material on the surface of the article thereby cold working the surface and providing a more shallow layer of compressive residual stress at the surface.

This application claims the benefit of U.S. Provisional Patent Application No. 60/848,076, filed Sep. 29, 2006.

### BACKGROUND OF THE INVENTION

The present invention relates to an apparatus and method for introducing an improved compressive residual stress distribution along at least a portion of the surface and to a depth below at least a portion of the surface of an article to improve resistance to stress related failure mechanisms and, more particularly, to a surface treatment apparatus with a textured contact surface for introducing a highly compressive layer along at least a portion of the surface and to a depth below at least a portion of the surface of an article.

The introduction of compressive residual stresses along and below the surface of an article is known to improve the fatigue and stress corrosion cracking performance of the article. A variety of different methods are used to introduce compressive residual stresses including shot peening, glass bead peening, gravity peening, impact peening, pinch peening, indenting, coining, burnishing, ultrasonic peening, cavitation peening, and laser shock peening. Each of these methods produces a characteristic residual stress distribution with respect to the depth and magnitude of the compressive stress induced.

By way of example, shot peening, a process in which a plurality of small, discrete shot pieces are energetically impinged against the surface of an article through pneumatic or mechanical means, provides a shallow layer of compressive residual stress at or near the surface of the article. The compressive residual stress introduced by shot peening is caused by both Hertzian loading of the impinged shot against the surface of the article and by the lateral displacement of material at the surface of the article due to the impact of the shot. A prototypical shot peening residual stress distribution is shown in FIG. 1. The highly compressive layer near the surface is primarily due to the lateral displacement of material at the surface during the shot peening operation. The relatively small size and high velocity of the shot cause significant lateral displacement and plastic deformation at the surface of the article, thereby producing a highly compressive surface layer of residual stress at the expense of depth and magnitude of subsurface compression. The subsurface compressive stress distribution is due to Hertzian loading under impact of the shot. The depth of the subsurface compressive stress is limited due to the size of the impacted shot. Further, the use of randomly impacted shot to achieve uniform surface coverage causes a high occurrence of areas subject to multiple impacts. The redundant impacts result in a highly cold worked surface that may be undesirable if thermally stable compressive residual stresses are desired. The repeated impacts of shot on the surface during the shot peening process can cause surface damage in the form of laps and folds that act as stress concentrations that serve an fatigue crack initiation sites, reducing fatigue strength. In some applications, residue from the peening media (usually steel, glass or ceramic shot) can degrade the fatigue or corrosion performance of the processed component. For example, during shot peening with steel shot, trace amounts of ferritic iron are left on the surface that can degrade corrosion performance. Bits of broken steel, ceramic or glass shot imbedded into the surface of components during shoot peening are know to serve as crack initiation sites that reduce fatigue life. Further, shot peening with any free-flying media requires some means of retaining and recovering the media. When the residual media may cause damage or corrosion of components or machinery, and full recovery of all of the media is not possible, shot peening may be prohibited. A convenient method of inducing surface compressive residual stress may not then be possible with any existing method. Therefore, an efficient, easily implemented method and apparatus for inducing a compressive residual stress along and below the surface of an article is needed which provides the depth and magnitude of compression of shot peening but without the risk of surface damage, contamination, or high cold working, and without the use for free-flying shot or particles.

By comparison, burnishing, a process in which a burnishing member such as a highly polished wheel, roller, or hydrostatically supported ball is pressed against and rolled over the surface of an article, introduces a compressive residual stress below the surface of the article while simultaneously improving the surface finish of the article as the smooth surface of the burnishing tool is imparted to the treated surface. As with shot peening, the form of the subsurface residual compressive stress distribution introduced along and below the surface of the article by burnishing is due to a combination of Hertzian loading of the tool against the surface of the article and the lateral displacement of surface material by the burnishing member. A prototypical burnishing residual stress distribution is also shown in FIG. 1. Because burnishing members are typically of much larger diameter than the shot used for peening, burnishing causes less lateral deformation of the immediate surface while imparting a much greater Hertzian load against the surface of the article being treated. As shown in FIG. 1, the magnitude of residual compressive stress produced by burnishing is often at a maximum beneath the surface of the article while the immediate below the surface of the article has comparatively low compressive stress. The lower magnitude of surface residual stress is due to the low lateral displacement of material at the surface while the high magnitude subsurface residual stress is due to the Hertzian loading effects of the burnishing element against the surface of the article. The presence of existing surface residual compressive stresses and cold work, usually from prior machining or other mechanical processing, may reduce the surface deformation during conventional burnishing with a smooth tool, resulting in further reduction of the residual surface compression. The presence of existing surface residual compressive stresses and cold work, usually from prior machining, shot peening, grit blasting, or other mechanical processing, may reduce the surface deformation during conventional burnishing with a smooth tool, resulting in reduced of the residual surface compression.

In order to provide the greatest improvement to the fatigue and stress corrosion cracking behavior of the article, it is desirable to have a layer of compressive residual stress that is both highly compressive on the surface and extends from the surface of the article to a depth below the surface of the article while avoiding damage or contamination of the surface. Unfortunately, such a compressive residual stress distribution is difficult to obtain with a single surface treatment method such as shot peening or burnishing.

To remedy this situation, processes have been developed to increase the stress levels at and below the surface of the article following burnishing. Such processes include removing a thin layer of material from the surface of the article by etching, electropolishing, mechanical polishing, or some other non-tensile stress forming process. Alternatively, a post-burnishing treatment, such as shot peening, grit blasting, or similar operation for introducing a shallow layer of high compression is applied in order to render the surface of the article more highly compressive. Unfortunately, both approaches require a secondary treatment unrelated to the original burnishing process thereby adding time, cost, complexity, and the potential for damage and loss of the article during manufacture.

Therefore, an efficient, easily implemented method and apparatus for inducing a compressive residual stress along and below the surface of an article is needed which provides the depth and magnitude of compression of a ball or roller burnishing tool with the surface compression of shot peening.

### SUMMARY OF THE INVENTION

The present invention satisfies the need for a method and apparatus for inducing high magnitude compressive residual stress at and below at least a portion of the surface of an article and high surface compression without introducing a high degree of cold working, damage, or contamination. The apparatus comprises a surface treatment element having at least one contact face for contacting the surface of an article and applying a Hertzian load thereto so as to introduce high magnitude compressive residual stress at and below at least a portion of the surface of the article. The at least one contact face has a plurality of small deforming features, such as nodules, bumps, dimples or ridges, or the like effective for causing lateral displacement and plastic deformation of the material at the surface of an article, increasing the effective contact area of the contact face with the article, and thus increasing the plastic strain at the surface when pressed against the work piece, and introducing highly compressive surface residual stresses.

According to another aspect of the invention, a method of improving the residual stress distribution of an article having at least one metallic portion includes the acts of: contacting the surface of the metallic portion with a surface treatment element having a contact face with a plurality of small deforming features disposed thereon; and applying pressure to the surface treatment element of just sufficient magnitude to deform the surface with the deformed features, but less than that required to cause Hertzian loading and subsurface deformation by the larger surface of the tool. A shallow layer of compression, comparable in depth and magnitude to conventional shot peening, is introduced in the surface, but without the high cold work or surface defects associated with repeated impacts in shot peening. Each surface location is deformed by a single indenting action, creating a layer of surface compression with much lower cold work, better process control and rapid processing than the random impact shot peening process.

In another preferred embodiment of the invention, the surface treatment element is manufactured from an alloy or material that will not leave any chemical residue on the surface of the work piece that will degrade the corrosion behavior or other chemical properties of the surface. Such surface treatment elements may be fabricated from hardened versions of the same alloy as the work piece.

In another preferred embodiment of the invention the contact face of the surface treatment element is curved.

In another preferred embodiment of the invention, the pressure applied to the tool is varied with position on the work piece to create a desired stress distribution along and below the surface of the article.

In another preferred embodiment of the invention the surface treatment element is in the form of a sphere, spheroid, ellipsoid, hemisphere, cylinder, cone or disk.

In another preferred embodiment of the invention the surface treatment element is selected from the list consisting of pinch peening elements, impact peening elements, indenting elements, and burnishing elements.

In another preferred embodiment of the invention the deforming features are uniformly spaced.

In another preferred embodiment of the invention the deforming features are randomly spaced.

In another preferred embodiment of the invention the deforming features are less than about 0.125 inches in diameter.

In operation, the surface treatment element is pressed against at least a portion of the surface of the article to be treated with sufficient force to cause plastic deformation deep beneath the surface by Hertzian loading. This introduces deep, high magnitude compressive residual stresses beneath the surface of the article. Simultaneously, material at the surface of the article is plastically deformed and laterally displaced by the small deforming features on the contact face of the surface treatment element. The lateral displacement and plastic deformation of the surface introduces a shallow layer of relatively high magnitude compressive residual stress at the surface of the article simultaneously with the development of relatively deep high magnitude compression by Hertzian loading.

According to another aspect of the invention, a method of improving the residual stress distribution of an article having at least one metallic portion includes the acts of: contacting the surface of the metallic portion with a surface treatment element having a contact face with a plurality of small deforming features disposed thereon; and applying pressure to the surface treatment element of sufficient magnitude to cause Hertzian loading and thereby inducing deep compressive residual stresses beneath the surface of the metallic portion while simultaneously causing the material at the surface of the metallic portion to plastically deform and conform to the deforming features of the contact face so as to induce shallow compressive residual stresses.

In another preferred embodiment of the invention the method further comprises the step of burnishing the surface of the metallic portion with a smooth burnishing element to eliminate surface roughness and cause additional lateral displacement and higher magnitude surface compression in the surface of the metallic portion.

According to another aspect of the invention, the method and apparatus of this invention is applied to an article having at least one metallic portion with an improved compressive residual stress distribution. The surface of each metallic portion is plastically deformed at discrete locations. A continuous compressive residual stress distribution extends from the surface of each metallic portion to a depth below the surface. The depth and magnitude of the continuous compressive stress distribution is greater than that obtainable with conventional shot peening operations. The plastic deformation at the surface of each metallic portion provides an improved bonding surface for the application of coatings.

In another preferred embodiment of the invention the article is selected from the group comprising aircraft and aircraft engine parts, power generating parts, automotive and automotive engine parts, gas and fluid distribution parts, gas and steam turbine components, steam generator parts, and nuclear components and weldments.

In another preferred embodiment of the invention, the method and apparatus of this invention may be applied using small portable tools to components, such as aircraft engine or structural parts in situ avoiding the need to remove the components. Such portable tools may be designed specifically for the geometry and location of the component in a larger structure.

### BRIEF DESCRIPTION OF THE DRAWINGS

These and other features, aspects, and advantages of the present invention will become better understood with regard to the following description, appended claims, and accompanying drawings where:

FIG. 1 is a plot illustrating a typical pattern of depth versus magnitude of compressive residual stress for shot peening and burnishing showing the effect of lateral displacement of surface material on the magnitude of compression for each treatment;

FIG. 2 is a schematic illustration of a preferred embodiment of the surface treatment element that is a subject of the present invention showing a surface treatment element where the deforming features are dimples;

FIG. 3 is a schematic illustration of another preferred embodiment of the surface treatment element that is a subject of the present invention showing a surface treatment element where the deforming features are hemispherical nodules;

FIG. 4 is a cross sectional illustration showing a method of using a preferred embodiment of the surface treatment element of the present invention;

FIG. 5 is a cross sectional illustration showing a method of using another preferred embodiment of the surface treatment element of the present invention;

FIG. 6 is a plot illustrating a typical pattern of depth versus magnitude of compressive residual stress distribution induced in the surface of an article by the surface treatment element and method of the present invention; and

FIG. 7 is an illustrative example of an article having a metallic portion with a residual stress distribution induced along the surface by the apparatus and method of the present invention.

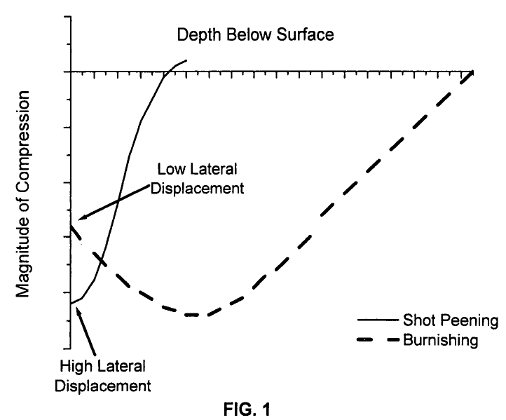

### DETAILED DESCRIPTION OF THE INVENTION

The present invention addresses the limitations of currently available surface treatment methods by providing an apparatus and method for producing an article having at least one metallic portion with a continuous, deep layer of high magnitude compressive residual stress that extends from the surface to a depth beneath the surface of at least one of the portion(s).

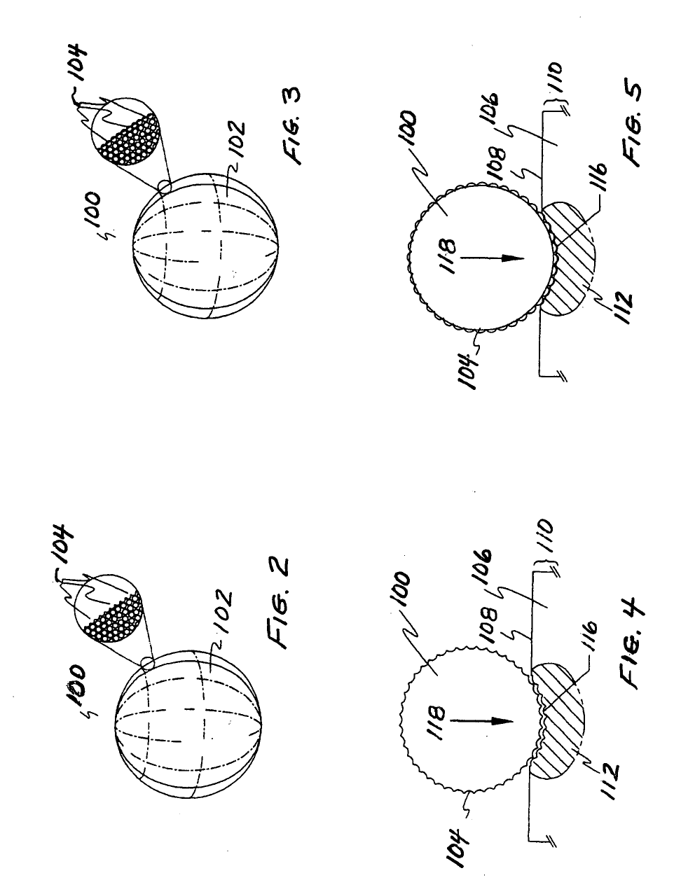

Referring to FIG. 2, the apparatus for improving the distribution of compressive stress is a surface treatment element 100 for use in conjunction with hydrostatic, ball-type burnishing tools, wheel or roller burnishing tools, indenting tools and impact/pinch peening tools. By way of example, the surface treatment element 100 shown in FIGS. 2 and 3 is a spherical element for use in conjunction with a conventional hydrostatic, ball-type burnishing tool. Alternatively, the surface treatment element may have a variety of forms including cylindrical, hemispherical, conical, or disk-shaped depending on the particular embodiment of the surface treatment apparatus in which it is employed.

The surface treatment element 100 has at least one contact face 102. The contact face 102 has a plurality of small deforming features 104 located thereon. The deforming features 104 may comprise hemispherical nodules, irregularly shaped nodules, dimples, ridges, crevices and combinations thereof. For an examplanary illustration, the preferred embodiment shown in FIG. 2, the deforming features 104 are in the form of semi-circular dimples. In another examplanary illustration the preferred embodiment shown in FIG. 3 the deforming features 104 are in the form of hemispherical nodules. The deforming features 104 may be of uniform size and geometry, comprise a distribution of sizes and geometries, or have random sizes and geometries. In one preferred embodiment, the dimensions of the deforming features 104 are about 3.2 mm (0.125 inches) in diameter to about 0.10 mm (0.004 inches) in diameter. The deforming features 104 may be arranged in a regular pattern or randomly positioned over the curved contact face 102. In another preferred embodiment, the size and/or spacing of the deforming features 104 is sufficient to produce local contact stresses at the deforming feature sufficient to indent the deforming features into and along the surface of the article being treated thereby causing plastic deformation and lateral flow of the surface.

In another preferred embodiment, the geometry, size, and/or spacing of the deforming features 104 are designed to produce a specified amount of plastic deformation, cold work, and/or magnitude of compressive residual stress for a given material forming the article or a portion of the article being treated. It should understood that one skilled in the art can, such as by the use of test specimens, can select the proper combination of geometry, size and spacing of the deforming features 104 to arrive at the proper combination to design the deforming feature 104 for generating the desired amount of plastic deformation, cold work, and/or magnitude of compressive residual stress.

Referring now to FIGS. 4 and 5, the surface treatment element 100, in connection with a standard surface treatment tool, such as a burnishing or pinch peening tool (not shown), is brought into contact with the surface 108 of a portion 106 of an article 110 to be treated. The portion 106 of the surface 108 of the article 110 is metallic. The surface treatment element 100 is pressed into the surface 108 of the article 110 by the application of a normal force 118. The magnitude of the normal force 118 is sufficient to cause Hertzian loading of the surface treatment element 100 on the surface 108 of the article 110 thereby introducing deep, high magnitude compressive residual stresses beneath the surface 108 of the portion 106.

As the surface treatment element 100 is pressed into the surface 108 of the portion 106, the deforming features 104 located on the surface treatment element 100 cause the material on the surface 108 of the portion 106 to be laterally displaced and plastically deformed. The deforming features 104 create a greater contact surface than a smooth surface treatment element of similar dimension thus causing greater displacement and plastic deformation at the surface. The displacement results in deformation on the surface 108 of the portion 106 similar to that caused by shot peening. However, the excessive deformation and cold work associated with shot peening is avoided due to the elimination of the random impacting required to achieve full coverage of the surface by shot peening.

The plastic deformation at the surface 108 causes the introduction of a shallow layer of high magnitude residual compressive stress in the treated portion 106 similar to that from shot peening but with lower cold working as the amount of material displacement is controlled and the redundant impact of shot is eliminated. The surface treatment element 100 is then rolled, as in the case of a hydrostatic ball, wheel, or roller tool, across the surface 108 of the portion 106 to introduce both deep and shallow compressive residual stresses in the predefined area. Alternatively, as in the case of a pinch peening, impact peening, or indenting operation, the surface treatment element 100 is repositioned relative to the surface 108 of the portion 106 being treated followed by application of force to indent the surface, and the process repeated.

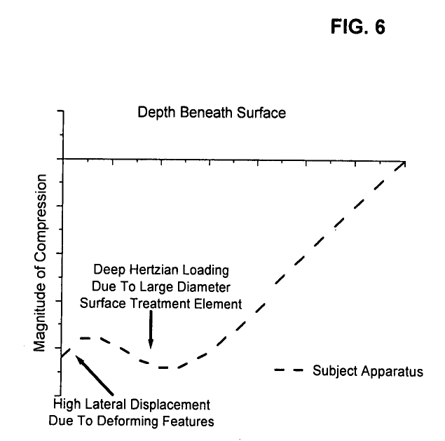

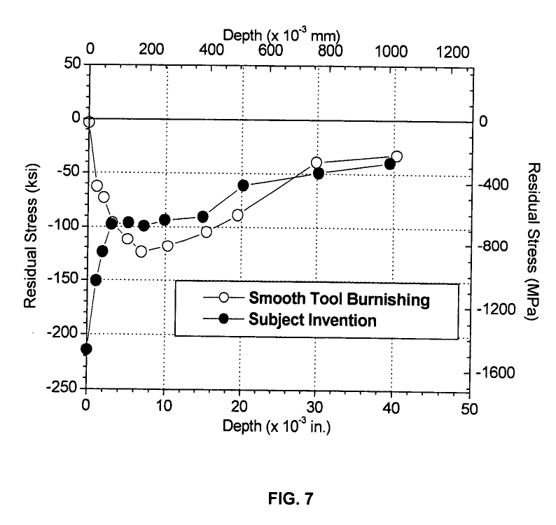

The resulting treated metallic portion(s) 106 has an improved residual stress distribution with a continuous layer of compressive residual stress 112 extending from the surface 108 to a depth beneath the surface of each treated portion(s) 106 that is greater than that of conventional shot peening. A typical residual stress distribution for the surface treatment element is shown in FIG. 6. As illustrated the distribution has both highly compressive surface residual stresses and due to the lateral displacement of surface material and deep, high magnitude subsurface residual stresses due to Hertzian loading. For an illustrative example, as illustrated in FIG. 7, a residual stress distribution of a article having a metallic portion formed from a highly work hardening austenitic stainless nickel base alloy, Alloy 22, is shown having been treated by conventional smooth tool burnishing and by the method and apparatus of the subject invention. For both samples, the forces and tool dimensions were identical, differing only in the texture of the surface of the surface treatment element. For purposes of this illustration, the smooth tool burnishing represents a conventional burnishing element having a smooth surface. The tool of the subject invention comprises the surface treatment element as described above. As illustrated, a layer of high compressive residual stress extends from the surface to a depth beneath the surface of the portion treated with the textured ball that is greater than that produced by the conventional smooth tool burnishing. As shown, the surface layer of low compression has been eliminated by the apparatus and method of the subject invention.

It should now be understood to one skilled in the art that the surface treatment apparatus and method of the subject invention leaves the surface of the treated portion(s) roughened. This roughened surface results in improving the adhesion of any coatings subsequently applied to the treated surface.

In another preferred embodiment of the invention, following treatment using the apparatus and method of the present invention, the surface of the treated portions is further burnished using a smooth ball, such as a conventional burnishing apparatus, to remove any dimples, ridges, etc., thereby causing further lateral displacement of the surface and even higher surface compression.

It should now be apparent to one skilled in the art that the subject method and apparatus may be used to improve the fatigue and stress corrosion cracking performance of a variety of metallic articles or metallic portions of articles and systems, such as articles used in the aircraft, automotive, rail, shipping, nuclear and petrochemical industries. This includes, but is not limited to, aircraft, naval, steam and ground-based turbines including turbine blades, disks, shafts, aircraft structural parts, aircraft landing gear and parts, metallic weldments, piping and parts used in nuclear, fossil fuel, steam, chemical, and gas plants, distribution piping for gases and fluids, automotive parts such as gears, springs, shafts, connecting rods, and bearings, ship hulls, propellers, impellers, and shafts, rail transport parts and tracks, and various other parts and structures too numerous to be mentioned herein.

It should also now be apparent to those skilled in the art that the described invention has many advantages, including the ability to produce deep, high magnitude compressive residual stress accompanied by higher magnitude surface compression than is otherwise achievable using smooth surface treatment elements, particularly in work hardening materials or surfaces previously cold worked. This eliminates the need for multiple surface treatments or other operations in order to produce the desired residual stress distribution and thereby reduces manufacturing costs and time.

Another advantage of the present invention is the ability to produce high magnitude surface compression with minimal cold work for improved thermal stability of compressive residual stresses.

Another advantage of the present invention is the ability to introduce beneficial residual compressive stresses in the part while simultaneously improving the mechanical bonding characteristics of the surface of an article so as to improve the adhesion of platings, paints, and other coatings.

Another advantage of the present invention is that the apparatus could be used at load levels much lower than what would be needed for Hertian loading of the full surface treatment element. In this way by pressing the deforming features into the surface of the article would produce the same results as shot peening (if the deforming features are the same size) but without the high cold work or the “laps and fold” type of damage caused by multiple impacts of shot peening. In addition, the method and apparatus of the present invention would eliminate scattered shot typically occurring with shot peening and which is not permitted or acceptable where shot left over could damage the mechanism or cause corrosion problems. Such systems include, but are not limited to for nuclear systems, jet engines, and high performance motors. Further, the present invention eliminates surface chemical contamination as often happens with ferrite residue on the surface of articles caused by shot peening by forming the surface treatment element from a hardened version of the article alloy or a harder similar alloy. The present apparatus can be used for many articles that previously must be dismantled, removed from another device and the like in order to be shot peened. It should now be apparent to one skilled in the art that the apparatus of the present invention can be of a size permitting many such articles to be treated without dismantling or removal from its location.

Although the present invention has been described in considerable detail with reference to certain preferred embodiments thereof, other embodiments are possible. Therefore, the scope of the appended claims should not be limited to the description of the preferred embodiments contained herein.

What is claimed is:

1. A surface treatment element for introducing deep and shallow compressive residual stresses in an article, the element comprising:
a surface for contacting and applying a Hertzian load to a surface of the article, the surface having a plurality of deforming features effective for causing the plastic deformation and lateral displacement of material on the surface of the article.

2. The surface treatment element of claim 1 wherein the surface treatment element is in the form of a sphere, spheroid, ellipsoid, hemisphere, cylinder, cone or disk.

3. The surface treatment element of claim 1 wherein the surface treatment element is selected from the list consisting of pinch peening elements, impact peening elements, indenting elements, and burnishing elements.

4. The surface treatment element of claim 1 wherein the deforming features are uniformly spaced.

5. The surface treatment element of claim 1 wherein the deforming features are randomly spaced.

6. The surface treatment element of claim 1 wherein the deforming features are bumps, nodules, ridges, dimples, craters, crevices and/or combinations thereof.

7. The surface treatment element of claim 1 wherein the deforming features are less than about 0.125 inches in diameter.

8. A method of improving the surface compression of an article having at least one metallic portion comprising the acts of:
contacting the surface of the metallic portion with a surface treatment element having a contact surface with a plurality of deforming features disposed thereon; and
applying pressure to the surface treatment element of sufficient magnitude to cause Hertzian loading thereby inducing deep compressive residual stresses beneath the surface of the metallic portion and causing the material at the surface of the metallic portion to be plastically deformed by the deforming features of the contact surface so as to induce shallow compressive residual stresses.

9. The method of claim 8 further comprising the act or rolling the surface treatment element over the surface of the metallic portion.

10. The method of claim 8 wherein the surface treatment element is selected from the list consisting of pinch peening elements, impact peening elements, indenting elements, and burnishing elements.

11. The method of claim 8 wherein the deforming features are less than about 0.125 inches in diameter.

12. The method of claim 8 further comprising the step of burnishing the surface of the metallic portion with a smooth burnishing element to eliminate surface roughness and cause additional lateral displacement and higher magnitude surface compression in the surface of the metallic portion.

13. A method of improving the surface compression of a portion of an article comprising the acts of:
applying a Hertzian load to at least one metallic portion of the surface of the article to introduce a deep compressive residual stress; and
plastically deforming discrete portions of the at least one metallic portion to introduce shallow compressive residual stress.

14. The method of claim 13 wherein the acts of applying a Hertzian load and plastically deforming are performed in a single operation.

15. The method of claim 13 wherein the acts of applying a Hertzian load and plastically deforming are performed using a surface treatment element having a surface for contacting and applying a Hertzian load to the surface of the metallic portion to introduce a deep compressive stress, the curved surface having a plurality of deforming features to cause the plastic deformation and lateral displacement of material on the surface of the metallic portion to introduce a shallow layer of compressive stress.

16. An article having at least one metallic portion with an improved residual compressive stress distribution comprising:
a surface plastically deformed at discrete locations;
a continuous residual compressive stress distribution extending from the surface to a depth beneath the surface of the metallic portion which is a depth greater than that obtainable by shot peening.

17. The article of claim 16 wherein the article is selected from the group comprising aircraft and aircraft engine parts, power generating parts, automotive and automotive engine parts, gas and fluid distribution parts, steam generator parts, and nuclear components and weldments.

18. An article with an improved residual compressive stress distribution comprising:
a metallic portion having a surface, the surface having a surface layer of compressive stress caused by plastic deformation at discrete locations along the surface, the compressive residual stress extending beneath the surface as a result of Hertzian loading.
